(19) United States
(12) Patent Application Publication
(10) Pub. No.: US 2022/0164650 A1
(43) Pub. Date: May 26, 2022

(54) MACHINE LEARNING-BASED METHOD FOR AUTOMATICALLY DETERMINING ABNORMAL POINTS OF SINGLE INDICATOR

(71) Applicant: Huaneng Tongliao Wind Power Co., Ltd., Tongliao (CN)

(72) Inventors: Guanghai Li, Tongliao (CN); Jinning Wang, Tongliao (CN); Guohui Zhang, Tongliao (CN); Wei Wu, Tongliao (CN); Yunlong Ma, Tongliao (CN); Wenbin Ma, Tongliao (CN); Xuechang Sun, Tongliao (CN); Xingyun Wang, Tongliao (CN)

(21) Appl. No.: 17/402,658

(22) Filed: Aug. 16, 2021

(30) Foreign Application Priority Data
Nov. 26, 2020 (CN) 202011347615.3

(51) Int. Cl. G06N 3/08; G06N 3/04

(52) U.S. Cl. CPC G06N 3/08; G06N 3/04

(57) ABSTRACT

A machine learning-based method for automatically determining abnormal points of a single indicator includes step 1: randomly selecting M sample points from training data as subsamples, and putting them into a root node of a tree; and step 2: randomly specifying a data dimension for projection, and randomly generating a cutting point p in data of a current node, where the cutting point is generated between a maximum value and a minimum value of the specified dimension in the data of the current node. The present disclosure optimizes conventional data analysis linear model functions and regression model functions, constructs a computer neural network in the algorithm, puts multiple perceptron parameters in a multi-layer network for learning and training, and adopts the principle of principal component analysis, to find out the abnormal data that violates the data correlation.

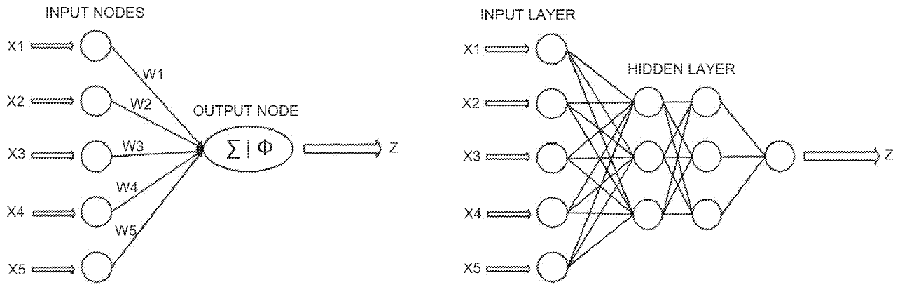

### CROSS REFERENCE TO RELATED APPLICATIONS

The present application claims the benefit of Chinese Patent Application No. 202011347615.3 filed on Nov. 26, 2020, the contents of which are incorporated herein by reference in their entirety.

### TECHNICAL FIELD

The present disclosure relates to the technical field of abnormal data mining in the power system, and specifically, to a machine learning-based method for automatically determining abnormal points of a single indicator.

### BACKGROUND

With the development of science and technology and society, enterprises and scientific research institutions have accumulated more and ever-increasing data in various fields. All walks of life are facing the opportunities and challenges brought by big data. There are a wide range of data sources in the power system, including a large amount of structured data such as alarm data and metering data, and a large amount of unstructured data such as meteorological data and operation ticket data. During daily equipment operation and maintenance of the power system, the abnormal data detection technology is of great significance. Effective abnormal data detection and determining methods may be used to monitor an abnormal operation state of the equipment, discover potential information in abnormal data, recognize and eliminate hidden dangers of equipment failure, and help the operation and maintenance personnel discover equipment defects and hidden dangers in time, and formulate equipment state maintenance plans in advance to ensure the stable operation of the equipment.

Currently, the method for mining abnormal data in the equipment performs detection and determining based on the probability and statistical model function. This method requires a standard data set that follows a certain probability distribution, and the Gaussian mixture model function is used to fit the actual data. Then, the deviation of the data from this model function is calculated to determine whether the data is abnormal. Although this method can obtain accurate results by standard statistical methods and formulas in mathematical concepts, the assumptions on the data are too simplified because the standard distribution followed by the data set usually cannot be known in practice, or the data does not follow any standard distribution. Thus, the abnormal data detection and determination method based on the probability and statistical model has great limitations and needs to be improved.

### SUMMARY

The purpose of the present disclosure is to provide a machine learning-based method for automatically determining abnormal points of a single indicator, to resolve the problems mentioned above: Although the abnormal data detection and determination method based on probability and statistical model functions can obtain accurate results by standard statistical methods and formulas in mathematical concepts, the assumptions on the data are too simplified because the standard distribution followed by the data set usually cannot be known in practice, or the data does not follow any standard distribution. Thus, the abnormal data detection and determination method based on the probability and statistical model has great limitations.

To achieve the above objectives, the present disclosure provides the following technical solution: A machine learning-based method for automatically determining abnormal points of a single indicator includes the following steps:

step 1: randomly selecting M sample points from training data as subsamples, and putting them into a root node of a tree;

step 2: randomly specifying a data dimension for projection, and randomly generating a cutting point p in data of a current node, where the cutting point is generated between a maximum value and a minimum value of the specified dimension in the data of the current node;

step 3: generating a hyperplane from this cutting point, and then dividing a data space of the current node into two subspaces: putting data less than p in the specified dimension in a left child node of the current node, and putting data greater than or equal to p in a right child node of the current node, where p indicates a random cutting point, is a randomly selected integer value, and is greater than 0;

step 4: recursively executing steps 2 and 3 in the child nodes, to continuously construct new child nodes, until the child node has only one piece of data or the child node has reached the defined height; and

step 5: for a piece of training data x, letting it traverse each child node, and then calculating a level of each child node that x finally falls on, that is, the height of x in the child node; then obtaining an average height of x in each child node; and after obtaining an average height of each piece of test data, setting a threshold, and determining test data whose average height is lower than the threshold as abnormal data.

Optionally, after t sub-nodes are obtained in step 4, the method includes completing training on a data set by a computer neural network, and using a generated algorithm model to evaluate abnormal data points in the test data, where t corresponds to a value of the defined height.

Optionally, in step 5, a basic structure of an automatic algorithm for determining abnormal points of a single indicator is as follows: D is assumed as a d-dimensional data set, where there are N samples, a covariance matrix of the data set is Σ, and the covariance matrix can be calculated diagonally: Σ=^{PΔP}^{^{T}}, where

P is a (d, d)-dimensional orthogonal matrix, and each column in the matrix is an eigenvector of Σ; Δ is a (d, d)-dimensional diagonal matrix with eigenvalues λ₁, . . . , and λₙ; on a two-dimensional plane, an eigenvector can be regarded as a line, and is regarded as a hyperplane when classification is performed in a high-dimensional space, each eigenvector corresponds to an eigenvalue, and the eigenvalue reflects a data stretch status in the direction of this eigenvector; in most cases, eigenvalues in the diagonal matrix Δ are arranged in descending order, and a corresponding eigenvector of each column in the matrix P is also adjusted, to enable an i^{th} column in P corresponds to an i^{th} diagonal value of Δ.

Optionally, projection of the data set D in a principal component space is in the following form:

Y=D×P, where

the projection is only performed on some dimensions; and if principal components of first j columns in a factorial matrix of the selected dimension data are used, a data set after projection is:

Y^{j}=D×P^{j}, where

P^{j} is the first j columns in the matrix P, that is, P^{j} is a (p, j)-dimensional matrix, and Y^{j} is a (N, j)-dimensional matrix.

Optionally, if mapping from a principal component space to an original space is considered, a reconstructed data set is:

R^{j}=(P^{j}×(Y^{j})^{T})^{T}=Y^{j}×(P^{j})^{T}, where

R is a data set reconstructed by principal components of the first j columns in the factorial matrix of the selected dimension data, and is a (N, p)-dimensional matrix, and an abnormal data score of the data Dᵢ=(D_{i,1}, . . . ,D_{i,p}) can be defined as follows:

$$Score ( {D}_{i} ) = ( {\sum }_{j = 1}^{d} ( ‖ {D}_{i} - {R}_{i}^{j} ‖ ) \times ev ( j ) \\ ev ( j ) = {\sum }_{k = 1}^{j} {λ}_{k} / {\sum }_{k = 1}^{d} {λ}_{k} ,$$

where

∥Dᵢ−Rᵢ^{j}∥ refers to a data set norm, ev(j) indicates a proportion of the principal components of the first j columns in the factorial matrix of the selected dimension data in all principal components, since the eigenvalues are arranged in descending order, ev(j) is in ascending order, which means that a higher j indicates more variances considered in ev(j); because summation is performed on 1 to j, the first principal component with a maximum deviation has a minimum weight, and the last principal component with a minimum deviation has a maximum weight 1; based on the analysis nature of the principal components, an abnormal value has a larger deviation in the final principal components, and an abnormal data point has a higher anomaly score.

The present disclosure provides a machine learning-based method for automatically determining abnormal points of a single indicator, which has the following beneficial effects:

(1) The present disclosure optimizes conventional data analysis linear model functions and regression model functions, constructs a computer neural network in the algorithm, puts multiple perceptron parameters in a multi-layer network for learning and training, and adopts the principle of principal component analysis, to find out the abnormal data that violates the data correlation. The present disclosure has the advantages of strong generalization ability, fewer training samples, and small determining error.

(2) The main method adopted in the present disclosure is to map the original data from the original space to the principal component space, and then map the projection back to the original space. The concept of boundary is used to avoid over-fitting of the data set, regularization used in the regression function or hinge loss function models is used to fit the data, and the decision boundary is used to separate the two types of data. Assuming that the origin is the only negative class, the kernel function is used to map the data to the high-dimensional space, to find a hyperplane that can be divided. The concept of slack variable is used to calculate and detect abnormal data. The operation method is simple and easy to use.

### BRIEF DESCRIPTION OF THE DRAWINGS

The sole FIGURE is a schematic diagram of a working principle of a computer neural network perceptron and a multilayer perceptron according to the present disclosure.

### DETAILED DESCRIPTION

The technical solutions in the embodiments of the present disclosure will be clearly and completely described below with reference to the accompanying drawings in the embodiments of the present disclosure.

As shown in the sole FIGURE, the present disclosure provides a technical solution: A machine learning-based method for automatically determining abnormal points of a single indicator includes the following steps:

Step 1: Randomly select M sample points from training data as subsamples, and put them into a root node of a tree.

Step 2: Randomly specify a data dimension for projection, and randomly generate a cutting point p in data of a current node, where the cutting point is generated between a maximum value and a minimum value of the specified dimension in the data of the current node.

Step 3: Generate a hyperplane from this cutting point, and then divide a data space of the current node into two subspaces: put data less than p in the specified dimension in a left child node of the current node, and put data greater than or equal to p in a right child node of the current node, where p indicates a random cutting point, is a randomly selected integer value, and is greater than 0.

Step 4: Recursively execute steps 2 and 3 in the child nodes, to continuously construct new child nodes, until the child node has only one piece of data or the child node has reached the defined height; and after t sub-nodes are obtained, complete training on a data set by a computer neural network, and use a generated algorithm model to evaluate abnormal data points in the test data, where t corresponds to a value of the defined height, and t indicates a preset neural network depth, and corresponds to a value of the above-mentioned defined height.

Step 5: For a piece of training data x, let it traverse each child node, and then calculate a level of each child node that x finally falls on, that is, the height of x in the child node; then obtain an average height of x in each child node; and after obtaining an average height of each piece of test data, set a threshold, and determine test data whose average height is lower than the threshold as abnormal data.

A basic structure of an automatic algorithm for determining abnormal points of a single indicator is as follows: D is assumed as a d-dimensional data set, where there are N samples, a covariance matrix of the data set is Σ, and the covariance matrix can be calculated diagonally: Σ=^{PΔP}^{^{T}}, where

P is a (d, d)-dimensional orthogonal matrix, and each column in the matrix is an eigenvector of Σ. Δ is a (d, d)-dimensional diagonal matrix with eigenvalues λ₁, . . . , and λₙ; on a two-dimensional plane, an eigenvector can be regarded as a line, and is regarded as a hyperplane when classification is performed in a high-dimensional space, each eigenvector corresponds to an eigenvalue, and the eigenvalue reflects a data stretch status in the direction of this eigenvector; in most cases, eigenvalues in the diagonal matrix Δ are arranged in descending order, and a corresponding eigenvector of each column in the matrix P is also adjusted, to enable an i^{th} column in P corresponds to an i^{th} diagonal value of A.

Projection of the data set D in a principal component space is in the following form:

Y=D×P, where

the projection is only performed on some dimensions; and if principal components of first j columns in a factorial matrix of the selected dimension data are used, a data set after projection is:

Y^{j}=D×P^{j}, where

P^{j} is the first j columns in the matrix P, that is, P^{j} is a (p, j)-dimensional matrix, and Y^{j} is a (N, j)-dimensional matrix.

If mapping from a principal component space to an original space is considered, a reconstructed data set is:

R^{j}=(P^{j}×(Y^{j})^{T})^{T}=Y^{j}×(P^{j})^{T}, where

R^{j} is a data set reconstructed by principal components of the first j columns in the factorial matrix of the selected dimension data, and is a (N, p)-dimensional matrix, and an abnormal data score of the data Dᵢ=(D_{i,1}, . . . ,D_{i,p}) can be defined as follows:

$$Score ( {D}_{i} ) = ( {\sum }_{j = 1}^{d} ( ‖ {D}_{i} - {R}_{i}^{j} ‖ ) \times ev ( j ) \\ ev ( j ) = {\sum }_{k = 1}^{j} {λ}_{k} / {\sum }_{k = 1}^{d} {λ}_{k}$$

∥Dᵢ−Rᵢ^{j}∥ refers to a data set norm, λₖ indicates a variance, and k indicates a value of the variance; ev(j) indicates a proportion of the principal components of the first j columns in the factorial matrix of the selected dimension data in all principal components, since the eigenvalues are arranged in descending order, ev(j) is in ascending order, which means that a higher j indicates more variances considered in ev(j); because summation is performed on 1 to j, the first principal component with a maximum deviation has a minimum weight, and the last principal component with a minimum deviation has a maximum weight 1; based on the analysis nature of the principal components, an abnormal value has a larger deviation in the final principal components, and an abnormal data point has a higher anomaly score.

In conclusion, the present disclosure optimizes conventional data analysis linear model functions and regression model functions, constructs a computer neural network in the algorithm, puts multiple perceptron parameters in a multi-layer network for learning and training, and adopts the principle of principal component analysis, to find out the abnormal data that violates the data correlation. The main method adopted in the present disclosure is to map the original data from the original space to the principal component space, and then map the projection back to the original space. The concept of boundary is used to avoid over-fitting of the data set, regularization used in the regression function or hinge loss function models is used to fit the data, and the decision boundary is used to separate the two types of data. Assuming that the origin is the only negative class, the kernel function is used to map the data to the high-dimensional space, to find a hyperplane that can be divided. The concept of slack variable is used to calculate and detect abnormal data. The method has the advantages of strong generalization ability, fewer training samples, and small determining error.

Although the examples of the present disclosure have been illustrated and described, it should be understood that those of ordinary skill in the art may make various changes, modifications, replacements and variations to the above examples without departing from the principle and spirit of the present disclosure, and the scope of the present disclosure is limited by the appended claims and their legal equivalents.

1. A machine learning-based method for automatically determining abnormal points of a single indicator, comprising the following steps:
step 1: randomly selecting M sample points from training data as subsamples, and putting them into a root node of a tree;
step 2: randomly specifying a data dimension for projection, and randomly generating a cutting point p in data of a current node, wherein the cutting point is generated between a maximum value and a minimum value of the specified dimension in the data of the current node;
step 3: generating a hyperplane from this cutting point, and then dividing a data space of the current node into two subspaces: putting data less than p in the specified dimension in a left child node of the current node, and putting data greater than or equal to p in a right child node of the current node, wherein p indicates a random cutting point, is a randomly selected integer value, and is greater than 0;
step 4: recursively executing steps 2 and 3 in the child nodes, to continuously construct new child nodes, until the child node has only one piece of data or the child node has reached the defined height; and
step 5: for a piece of training data x, letting it traverse each child node, and then calculating a level of each child node that x finally falls on, that is, the height of x in the child node; then obtaining an average height of x in each child node; and after obtaining an average height of each piece of test data, setting a threshold, and determining test data whose average height is lower than the threshold as abnormal data.

2. The machine learning-based method for automatically determining abnormal points of a single indicator according to claim 1, wherein after t sub-nodes are obtained in step 4, the method comprises completing training on a data set by a computer neural network, and using a generated algorithm model to evaluate abnormal data points in the test data, wherein t corresponds to a value of the defined height.

3. The machine learning-based method for automatically determining abnormal points of a single indicator according to claim 1, wherein in step 5, a basic structure of an automatic algorithm for determining abnormal points of a single indicator is as follows: D is assumed as a d-dimensional data set, wherein there are N samples, a covariance matrix of the data set is Σ, and the covariance matrix can be calculated diagonally: Σ=^{PΔP}^{^{T}}, wherein
P is a (d, d)-dimensional orthogonal matrix, and each column in the matrix is an eigenvector of Σ; Δ is a (d, d)-dimensional diagonal matrix with eigenvalues λ₁, . . . , and λₙ; on a two-dimensional plane, an eigenvector can be regarded as a line, and is regarded as a hyperplane when classification is performed in a high-dimensional space, each eigenvector corresponds to an eigenvalue, and the eigenvalue reflects a data stretch status in the direction of this eigenvector; in most cases, eigenvalues in the diagonal matrix Δ are arranged in descending order, and a corresponding eigenvector of each column in the matrix P is also adjusted, to enable an i^{th} column in P corresponds to an i^{th} diagonal value of Δ.

4. The machine learning-based method for automatically determining abnormal points of a single indicator according to claim 3, wherein projection of the data set D in a principal component space is in the following form:
Y=D×P, wherein
the projection is only performed on some dimensions; and if principal components of first j columns in a factorial matrix of the selected dimension data are used, a data set after projection is:
Y^{j}=D×P^{j}, wherein
P^{j} is the first j columns in the matrix P, that is, P^{j} is a (p, j)-dimensional matrix, and Y^{j} is a (N, j)-dimensional matrix.

5. The machine learning-based method for automatically determining abnormal points of a single indicator according to claim 4, wherein if mapping from a principal component space to an original space is considered, a reconstructed data set is:
R^{j}=(P^{j}×(Y^{j})^{T})^{T}=Y^{j}×(P^{j})^{T}, wherein
R^{j} is a data set reconstructed by principal components of the first j columns in the factorial matrix of the selected dimension data, and is a (N, p)-dimensional matrix, and an abnormal data score of the data Dᵢ=(D_{i,1}, . . . ,D_{i,p}) can be defined as follows:
$$Score ( {D}_{i} ) = ( {\sum }_{j = 1}^{d} ( ‖ {D}_{i} - {R}_{i}^{j} ‖ ) \times ev ( j ) \\ ev ( j ) = {\sum }_{k = 1}^{j} {λ}_{k} / {\sum }_{k = 1}^{d} {λ}_{k} ,$$
wherein
∥Dᵢ−Rᵢ^{j}∥ refers to a data set norm, ev(j) indicates a proportion of the principal components of the first j columns in the factorial matrix of the selected dimension data in all principal components, since the eigenvalues are arranged in descending order, ev(j) is in ascending order, which means that a higher j indicates more variances considered in ev(j); because summation is performed on 1 to j, the first principal component with a maximum deviation has a minimum weight, and the last principal component with a minimum deviation has a maximum weight 1; based on the analysis nature of the principal components, an abnormal value has a larger deviation in the final principal components, and an abnormal data point has a higher anomaly score.
